(19) United States
(12) Patent Application Publication
(10) Pub. No.: US 2022/0159918 A1
(43) Pub. Date: May 26, 2022

(54) MULTIPLE PRODUCE GROWTH SUPPORT APPARATUS

(71) Applicant: AUTO GROW POD, LTD., Tel Aviv (IL)

(72) Inventor: MICHAEL MAMAN, HAIFA (IL)

(21) Appl. No.: 17/525,907

(22) Filed: Nov. 14, 2021

Related U.S. Application Data
(60) Provisional application No. 63/117,471, filed on Nov. 24, 2020.

(51) Int. Cl. A01G 31/02; A01G 24/50; A01G 7/04; A01G 24/22

(52) U.S. Cl. CPC A01G 31/02; A01G 24/22; A01G 7/045; A01G 24/50

(57) ABSTRACT

A multiple produce growth support apparatus comprises a plurality of growth supports having a growth substrate and produce arranged to grow within said respective growth substrate; a connection assembly, each of said plurality of growth supports connected to said connection assembly; an irrigation assembly arranged to irrigate said plurality of growth supports; and a rotation mechanism coupled to said connection assembly and arranged to rotate said plurality of growth supports about a predetermined rotation axis, wherein, when at least one of said growth support provides at least one growth substrate that is ready to be sold to the consumers said at least one growth substrate is moved to the section that is visible to present and deliver the produce to said consumers; whereby, said apparatus provides consumers with fresh produce directly from said growth substrate.

### FIELD OF THE INVENTION

The present invention relates generally to the field of produce retail, and in particular to a multiple produce growth support system and method.

### BACKGROUND OF THE INVENTION

A growing trend in the field of produce retail is the desire of consumers to purchase fresher produce, preferably clean of insecticides and pests. Fresher produce tastes better and lasts longer in the consumer's home. In order to meet the demand of fresh produce, it has become an important objective to reduce the amount of time between harvest of the produce and delivery to retail vendors. However, this increases complexity and cost to the harvesting and supply process.

### SUMMARY OF THE INVENTION

Accordingly, it is a principal object of the present invention to overcome disadvantages of prior art methods and arrangements of produce retail.

In accordance with one aspect of the present invention there is provided a multiple produce growth support apparatus comprising: a plurality of growth supports; a connection assembly, each of the plurality of growth supports connected to the connection assembly; an irrigation assembly arranged to irrigate the plurality of growth supports; and a rotation mechanism coupled to the connection assembly and arranged to rotate the plurality of growth supports about a predetermined rotation axis, wherein each of the plurality of growth supports comprises: a growth substrate; and produce arranged to grow within the respective growth substrate.

In accordance with another aspect of the present invention there is provided a multiple produce growth support apparatus having a plurality of growth supports with a growth substrate and produce arranged to grow within the respective growth substrate. A connection assembly, each of the plurality of growth supports are connected to the connection assembly. An irrigation assembly arranged to irrigate the plurality of growth supports. A rotation mechanism coupled to the connection assembly and arranged to rotate the plurality of growth supports about a predetermined rotation axis. Each growth support provides different plant growth conditions and monitoring accessories. Once the produce of growth substrate reaches a predetermined growth phase, said growth substrate moves to another growth support to accommodate for its current growth requirements until it is ready to be sold to the consumers. when the produce is ready to be sold to consumers, then the growth substrate is moved to the section that is visible to present and deliver the produce to the consumers.

Yet in another aspect of the present invention there is provided a multiple produce growth support apparatus having a plurality of growth supports having a growth substrate and produce arranged to grow within the respective growth substrate. A connection assembly, each of said plurality of growth supports connected to the connection assembly. An irrigation assembly arranged to irrigate the plurality of growth supports. A rotation mechanism coupled to the connection assembly and arranged to rotate the plurality of growth supports about a predetermined rotation axis, when at least one of said growth support provides at least one growth substrate that is ready to be sold to the consumers said at least one growth substrate is moved to the section that is visible to present and deliver the produce to the consumers and provides consumers with fresh produce directly from the growth substrate.

### BRIEF DESCRIPTION OF THE DRAWINGS

Additional features and advantages of the invention will become apparent from the following drawings and description. For a better understanding of the invention and to show how the same may be carried into effect, reference will now be made, purely by way of example, to the accompanying drawings in which like numerals designate corresponding elements or sections throughout. With specific reference now to the drawings in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. In the accompanying drawings:

FIG. 1A illustrates a high level side view of a first embodiment of multiple produce growth support apparatus;

FIG. 1B illustrates a high level frontal view of the first embodiment of multiple produce growth support apparatus;

FIG. 1C illustrates an additional high level side view of the first embodiment of multiple produce growth support apparatus;

FIG. 1D illustrates a high level side view of a second embodiment of multiple produce growth support apparatus; and

FIG. 1E illustrates a high level perspective view of multiple produce growth support apparatus.

### DETAILED DESCRIPTION OF THE ILLUSTRATED EMBODIMENTS

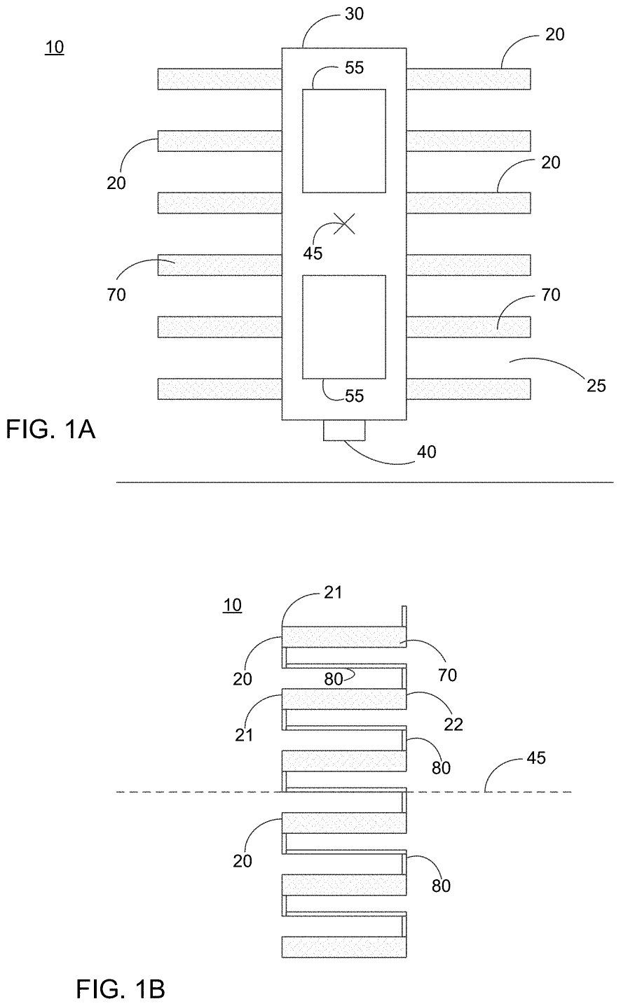

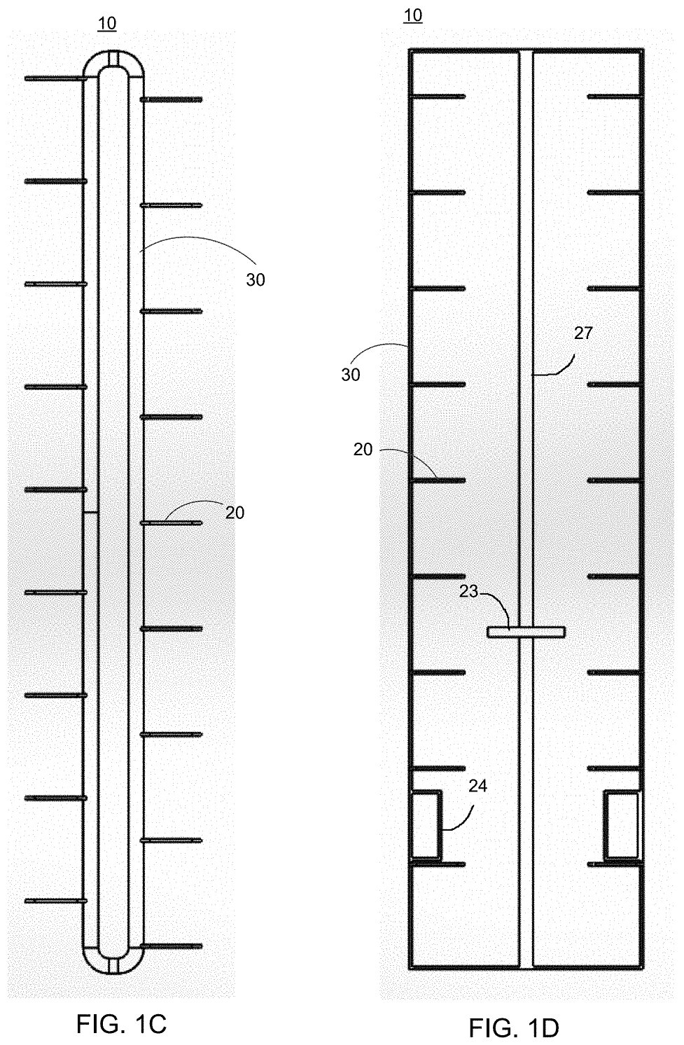

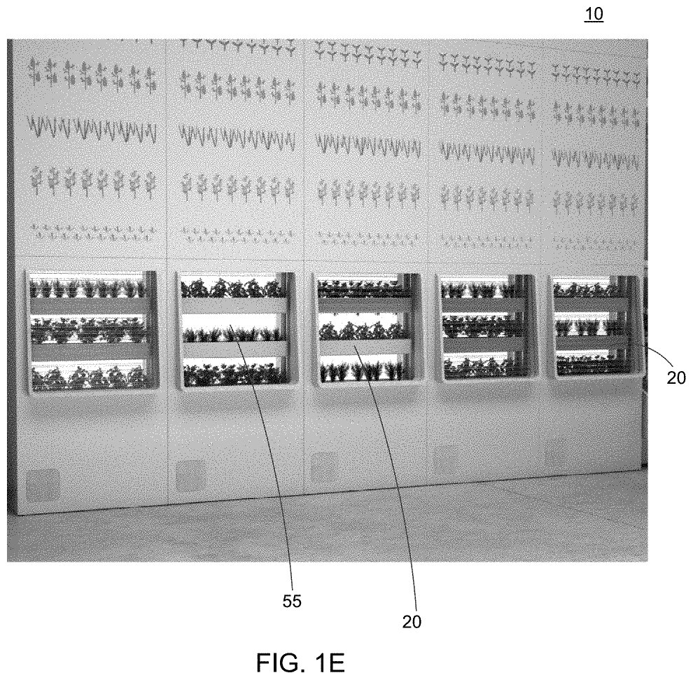

Referring now to FIGS. 1A-1E, multiple produce growth support apparatus 10 comprises: a plurality of growth supports 20; a connection assembly 30; a rotation mechanism 40; an irrigation assembly (will describe later with more detail); and one or more lighting assemblies 55. Each growth support 20 is connected to connection assembly 30.

Each growth support 20 extends from a first side 21 to a second side 22. In one embodiment, each growth support 20 is generally parallel to a floor. In another embodiment, each growth support 20 is generally rectangular shaped, however, this is not meant to be limiting in any way. Growth supports 20 are arranged about a rotation axis 45. In one embodiment, a first and second set of growth supports 20 are each arranged in a stacked formation, such that each growth support 20 is positioned above an adjacent growth support 20, with a space 25 between them. Each set of growth supports 20 are positioned on opposing sides of rotation axis 45. As will be described below, growth supports 20 are rotated about rotation axis 45, such that growth supports 20 switches between being in the first set and the second set. In a first embodiment, as illustrated in FIGS. 1A and 1C, growth supports 20 are arranged around connection assembly 30, that is, growth supports 20 extend outwards from connection assembly 30 and connection assembly 30 is positioned between the first and second set of growth supports 20.

In a second embodiment, as illustrated in FIG. 1D, connection assembly 30 surrounds growth supports 20, that is, growth supports 20 extend inwards from connection assembly 30. An actuated arm 23 actuated for example by an electric motor (not shown) controlled by a controller (not shown) can be automatically move up or down along the central axis 27 of growth support apparatus 10. The actuated arm 23 may also include a pull out and push in electromechanical assembly that can pull out one or more produce units or growth substrates 70 from surround growth support 20 or push in produce units or substrate 70 to another surround growth support 20 that surrounds connection assembly 30. The movement of the actuated arm and the pull out and push in electromechanical assembly can be controlled by a controller executing a predetermined plant growth protocol which can be different for each type of produce such as but not limited tomatoes, eggplant, cucumbers, melons, leaves and lettuce, green vegetables, herbs, spinach leaves, parsley, coriander, and oregano. The plant growth protocol may include for example the required growth space, temperature, lighting conditions, irrigation requirements and each growth protocol have a predetermined duration of complete growth cycle based on the specific produce being grown. The actuated arm 23 along with the pull out and push in electromechanical assembly transports for example growth substrate 70 from one growth support 20 to another growth support 20 based on their respective growth state.

Each growth support 20 provides different plant growth conditions, including but not limited to lighting, temperature, moisture and height, and monitoring accessories thereof including but not limited to temperature sensor, moisture sensor, height sensor, camera, image processing unit, control units, CPU, and timers, to monitor the plant growth and detect possible malfunctions, for example, pests, and plant diseases. Once said produce of growth substrate 70 reaches a predetermined growth phase, arm 23 is instructed by the controller to moves the growth substrate 70 to another growth support 20 to accommodate for its current growth requirements until it is ready to be sold to the consumers or moved to a different growth support 20. When the produce is ready to be sold to consumers, then arm 23 moves the growth substrate 70 to the section 24 that is visible to present and deliver the produce to the consumers.

In another embodiment of the present invention (not shown) the multiple produce growth support apparatus 10 can further comprise a system (known in the art) for automatic growth of different types of plants using the various sensors, computer vision capabilities, image processing unit, said system provides independent decision-making capabilities and enables the use of an evolving database and plant growth modeling building (optimal growth plans) for different plant varieties, identification of various problems and recovery methods and techniques. To this end, the system supports all of the following: automatic and optimal feeding of plants in every required parameter and controlling its environment (for example, lighting, temperature, CO2 levels, fertilization, humidity) without human intervention, in a closed space; the use of a cloud based plant growth databases (or internal database) to use, build, and improve plant growing modules and protocols and to detect plant growth problems automatically including but not limited to pests, viruses and various plant diseases.

In another embodiment of the present invention, the distance between the different growth support shelves 20 is changeable and is determined by the type of produce being grown and the growing protocol.

Each growth support 20 comprises a growth substrate 70. In one embodiment, growth substrate 70 comprises soil, and further optionally comprises fertilizer. In another embodiment, growth substrate 70 is contained within one or more removable units. In one further embodiment, growth substrate 70 is contained within a mesh. Seeds are planted within growth substrate 70 such that produce grows within growth substrate 70, as will be described below. In one embodiment (not shown), each growth support 20 further comprises a seeder mechanism which is arranged to automatically seed growth substrate 70 with seeds contained within a seed storage unit.

In another embodiment of the present invention, growth substrate 70 comprises “agar”, a jelly-like substance consisting of polysaccharides obtained from the cell walls of some species of red algae, primarily from ogonori (Gracilaria) and “tengusa” (Gelidiaceae) that can also contain all the required minerals, liquids and fertilizers that are required for the plant growth from the seeding until harvest or selling to the consumer. One of the advantages of using agar in the multiple produce growth support apparatus 10 is that the use of agar in lieu of regular soil makes the irrigation action unnecessary and thus reduces overall costs.

Irrigation assembly is arranged to irrigate growth substrate 70 of each growth support 20. In one embodiment, the irrigation assembly is arranged by supplying water to the top growth support 20 of each set and the water flows through pipes 80 to the lower growth supports. Particularly, in one embodiment, each pipe 80 extends from first end 21 of each growth support 20 to second end 22 of the adjacent growth support 20 directly below. As a result, water enters each growth support 20 at second end 22 thereof. When the respective growth support 20 fills with water, excess water exits the respective growth support 20 at first end 21 and flows to the adjacent growth support 20. In one embodiment, the flow of water between growth supports 20 is performed by gravity. In one embodiment (not shown), water is supplied to pipes 80 from a water tank. In another embodiment, pipes 80 are connected to an external water pipe.

In one embodiment, lighting assemblies 55 are positioned between the sets of growth supports 20. In another embodiment (not shown), additionally or alternatively, lighting assemblies 55 are positioned on walls of multiple produce growth support apparatus 10. In one embodiment, each lighting assembly comprises a screen which emits light. Each lighting assembly 55 is coupled to a power source (not shown). In one embodiment (not shown), an air treatment unit is further provided, optionally connected to a ventilation or air conditioning system of a building.

Rotation mechanism 40 rotates connection assembly 30 such that growth supports 20 are rotated about rotation axis 45. Particularly, rotation mechanism 40 translates each growth support 20 of the first set downwards and each growth support 20 of the second set upwards. The distance of translation equals the combination of the width of space 25 and the thickness of growth support 20. Additionally, the lowest growth support 20 of the first set is translated to the second set and the uppermost growth support 20 of the second set is translated to the first set. Optionally, the translation of growth supports 20 is performed once a day, at a predetermined time. The number of growths supports 20 is selected such that the produce growing in growth substrate 70 can sufficiently grow during an entire rotation cycle about rotation axis 45.

Thus, the lowest growth support 20 of the first set, which contains grown and ready to be sold produce, is presented to consumers who can cut a desired amount of produce. Alternatively, in an embodiment where growth substrate 70 comprises a plurality of removable units, consumers can remove a unit of growth substrate 70 which contains produce that the consumer wishes to purchase. At the predetermined time, the respective growth support 20, whose produce has been purchased, is reseeded and translated to the second set of growth supports 20, that is, to the back. In one embodiment, as described above, growth support 20 is reseeded automatically by a seeder mechanism. In another embodiment, growth support 20 is reseeded manually. Optionally, the respective growth substrate is further replaced.

Although the above has been described in relation to an embodiment where the growth support 20 containing produce ready to be purchased is lowered from the top to the bottom, this is not meant to be limiting in any way. In another embodiment, growth supports 20 are rotated about rotation axis 45 such that growth supports 20 rise up in the front and are lowered in the back. In such an embodiment, the growth support 20 whose produce has been purchased is translated upwards.

Although the above has been described in relation to an embodiment where a single growth support 20 is presented to the consumer, this is not meant to be limiting in any way. As illustrated in FIG. 1E, a group of growth supports 20 are presented to the consumers. In one non-limiting example, as illustrated, 3 growth supports 20, containing grown produce is presented to the consumers. In such an example, the translation of growth supports 20 by rotation mechanism 45 is along a distance equal to the combination of the width of space 25 and the thickness of growth support 20, multiplied by 3.

In one embodiment, the seeder mechanism, rotation mechanism 40, irrigation assembly 50 and/or lighting assemblies 55 are controlled by a dedicated application on a computer or smartphone.

In another embodiment of the present invention, multiple produce growth support apparatus 10 is a closed air system further comprising an air conditioning system (not shown) that is connected to the building's air conditioning system, inlet HEPA filters (high-efficiency particulate air) of at least 3 micron filtration (not shown). Multiple produce growth support apparatus 10 maintains a constant positive air pressure relatively to the space wherein the multiple produce growth support apparatus 10 is located in to prevent the entrance of contaminants, pests and plant diseases into the produce growth support apparatus 10.

Multiple produce growth support apparatus 10 thus provides consumers with fresh produce directly from growth substrate 70. A wide variety of fresh produce can be provided, including, without limitation, baby leaves, mustard seeds, beets, lettuce, cabbage, and kale. Multiple produce growth support apparatus 10 can be used in supermarkets, small stores, outdoor vendors, and plant nurseries. Advantageously, the fresh produce lasts longer. Further advantageously, multiple produce growth support apparatus 10 eliminates the dependence on weather and quality of the environment. Additionally, the need for transportation and storage of the produce is eliminated, thereby the retailer does not have to purchase and maintain expensive storage refrigerators, nor does the retailer need to manage inventory for the produce. Furthermore, the large waste, which is common in the industry, is nearly eliminated. All these advantages are achieved while utilizing space which is already normally used for display of such produce.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

What is claimed and desired to be protected by Letters Patent, is:

1. A multiple produce growth support apparatus comprising:
a plurality of growth supports having a growth substrate and produce arranged to grow within said respective growth substrate;
a connection assembly, each of said plurality of growth supports connected to said connection assembly;
an irrigation assembly arranged to irrigate said plurality of growth supports; and
a rotation mechanism coupled to said connection assembly and arranged to rotate said plurality of growth supports about a predetermined rotation axis,
wherein, when at least one of said growth support provides at least one growth substrate that is ready to be sold to the consumers said at least one growth substrate is moved to the section that is visible to present and deliver the produce to said consumers;
whereby, said apparatus provides consumers with fresh produce directly from said growth substrate.

2. A multiple produce growth support apparatus according to claim 1, wherein:
once said produce of growth substrate reaches a predetermined growth phase, said growth substrate is moved to another growth support to accommodate for its current growth requirements until it is ready to be sold to the consumers;
when said produce is ready to be sold to consumers, then the growth substrate is moved to the section that is visible to present and deliver the produce to the consumers;
whereby, said apparatus provides consumers with fresh produce directly from said growth substrate.

3. A multiple produce growth support apparatus according to claim 1 wherein:
said growth substrate is contained within one or more removable units.

4. A multiple produce growth support apparatus according to claim 1 wherein:
said growth substrate is contained within a mesh.

5. A multiple produce growth support apparatus according to claim 1 wherein:
said growth support apparatus further comprises a seeder mechanism which is arranged to automatically seed said growth substrate with seeds contained within a seed storage unit.

6. A multiple produce growth support apparatus according to claim 1 wherein:
said growth support apparatus further comprising an irrigation assembly arranged to irrigate said growth substrate of each said growth support.

7. A multiple produce growth support apparatus according to claim 6 wherein:
said irrigation assembly having plurality of water pipes wherein water is supplied to the top growth support and the water flows through said pipes to the lower growth supports.

8. A multiple produce growth support apparatus according to claim 6 wherein:
each of said water pipes extends from a first end of each growth support to a second end of an adjacent growth support directly below,
whereby, water enters each of said growth support one after another from bottom down in a way that when one of said respective growth support fills with water, excess water exits said respective growth support at first end of said respective growth support and flows to the adjacent growth support.

9. A multiple produce growth support apparatus according to claim 1 wherein:
said apparatus comprising lighting assemblies positioned between the sets of said growth supports.

10. A multiple produce growth support apparatus according to claim 1 wherein:
each of said lighting assemblies comprises a screen which emits light.

11. A multiple produce growth support apparatus according to claim 1 wherein:
said apparatus further comprising an air treatment unit connected to a ventilation or air conditioning system of a building.

12. A multiple produce growth support apparatus according to claim 1 wherein:
said rotation mechanism translates each of said growth support of the first set downwards and each growth support of the second set upwards where the distance of translation equals the combination of the width of space and the thickness of growth support.

13. A multiple produce growth support apparatus according to claim 1 wherein:
a first and a second set of growth supports are each arranged in a stacked formation, such that each growth support is positioned above an adjacent growth support, with a space between them; each set of growth supports are positioned on opposing sides of said predetermine rotation axis;
wherein, said growth supports are rotated about said predetermined rotation axis, such that said growth supports from said growth support sets switch between being in the first set and the second set.

14. A multiple produce growth support apparatus according to claim 1 wherein:
said connection assembly surrounds said growth supports, said growth support apparatus further comprising an actuated arm controlled by a controller, said arm automatically move up or down along said rotation axis of said growth support apparatus; and
said actuated arm comprise a pull out and push in electromechanical assembly that can pull out one or more of said produce units or said substrates from said growth support or push in produce units or substrate to another growth support that surrounds said connection assembly.

15. A multiple produce growth support apparatus according to claim 1 wherein, said movement of the actuated arm and the pull out and push in electromechanical assembly is controlled by a controller executing a predetermined plant growth protocol which can be different for each type of produce such as but not limited to leaves and lettuces, green vegetables, herbs, spinach leaves, parsley, coriander, and oregano; said plant protocol comprising the required growth space, temperature, lighting conditions, irrigation requirements and each growth protocol have a predetermined duration of complete growth cycle based on the specific produce being grown; said actuated arm along with said pull out and push electromechanical assembly transports said growth substrate from one growth support to another growth support based on their respective growth state.

16. A multiple produce growth support apparatus according to claim 1, wherein:
the distance between the different growth support shelves is changeable and is determined by the type of produce being grown and the growing protocol.

17. A multiple produce growth support apparatus according to claim 1 wherein:
each growth support provides different plant growth conditions and monitoring accessories.

18. A multiple produce growth support apparatus according to claim 1 wherein:
at least one of said growth substrates comprises agar.

19. A multiple produce growth support apparatus according to claim 1 wherein:
said growth support apparatus is a closed system further comprising an air conditioning system that is connected to the building's air conditioning system; and
wherein said multiple produce growth support apparatus maintains a constant positive air pressure relatively to the space where the multiple produce growth support apparatus is located.
